(19) United States
(12) Patent Application Publication
(10) Pub. No.: US 2020/0336095 A1
(43) Pub. Date: Oct. 22, 2020

(54) POWER TOOL OPERATION METHOD

(71) Applicant: Yu-Chen CHIEN, Nantou City (TW)

(72) Inventor: Yu-Chen CHIEN, Nantou City (TW)

(21) Appl. No.: 16/502,841

(22) Filed: Jul. 3, 2019

(30) Foreign Application Priority Data
Apr. 18, 2019 (TW) 108113634

(51) Int. Cl. H02P 25/16; H02P 29/00; H02P 3/18

(52) U.S. Cl. CPC H02P 25/16; H02P 3/18; H02P 29/00

(57) ABSTRACT

A power tool operation method includes the step of providing a light load trigger condition and a target torque parameter, the step of triggering an electric drive of a power tool through a drive current to cause the electric drive to generate an operating signal, the step of monitoring the operating signal of the electric drive, the step of limiting the maximum current change rate of the drive current when the operating signal satisfied the light load trigger condition, so that the electric drive operates at a reduced speed, the step of monitoring an output torque value of the electric drive, and the step of stopping the output of the drive current when the output torque value satisfied the target torque parameter.

### BACKGROUND OF THE INVENTION

### 1. Field of the Invention

The present invention relates to power tool technology and more particular, to a power tool operation method.

### 2. Description of the Related Art

A power tool usually locks a screw component according to the set target torque value and allows the electric motor to run at a high speed to achieve an efficient locking operation. However, when the screw component is locked in this way, the motor shaft of the electric motor is still at a high speed. Therefore, when the electric motor is turned off at a high speed, the operator will obviously feel the reaction force of the feedback of the shaft of the electric motor, and the reaction force will make the torque unable to be accurately controlled.

If the electric motor is kept at a lower speed before locking in order to avoid the reaction force, the torque can be controlled more accurately, however, because the entire locking stroke is running at low speed, the power tool cannot achieve better locking efficiency.

### SUMMARY OF THE INVENTION

The present invention has been accomplished under the circumstances in view. It is therefore the main object of the present invention to provide a power tool operation method, which can effectively control the drive current through the transition time point of the light load operation and the heavy load operation, thereby achieving the torque control of the electric motor and avoiding the reaction force generated by the electric motor at the time the electric motor is turned off.

To achieve this and other objects of the present invention, a power tool operation method includes the step of providing a light load trigger condition and a target torque parameter, the step of triggering an electric drive of a power tool through a drive current to cause the electric drive to generate an operating signal, the step of monitoring the operating signal of the electric drive, the step of limiting a maximum current change rate of the drive current when the operating signal satisfied the light load trigger condition, so that the electric drive operates at a reduced speed, the step of monitoring an output torque value of the electric drive, and the step of stopping the output of the drive current when the output torque value satisfied the target torque parameter.

In this way, the power tool operation method of the present invention can effectively monitor the transition time point of the operation signal through the light load trigger condition, and the light load trigger condition can be preset or established by tracking the operating signal. After the transition time point occurs, the rate of change of the drive current is limited to control and reduce the rotation speed of the electric drive, so that the output torque value of the electric drive at the low rotation speed meets the target torque value, and the torque control is achieved and the reaction force of the electric drive is avoided.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 illustrates a power tool in accordance with the present invention.

FIG. 2 is a block diagram of the electric drive of the power tool shown in FIG. 1.

FIG. 3 is a flow chart of the power tool operation method of the power tool shown in FIG. 1.

FIG. 4 is a waveform diagram of the drive current corresponding to the drive current measured by an oscilloscope.

FIG. 5 is a circuit diagram of the electric drive shown in FIG. 2.

FIG. 6 illustrates an alternate form of the circuit diagram of the electric drive shown in FIG. 2.

FIG. 7 is a block diagram of an alternate form of the electric drive of the power tool shown in FIG. 1.

### DETAILED DESCRIPTION OF THE INVENTION

Hereinafter, the devices, circuit, flow, steps, and achievement of the power tool operation method of the present invention will be described by way of the preferred embodiment with reference to the annexed drawings. However, the devices, circuits, flow, steps, and appearance of the power tool and its operation method in each drawing are only used to illustrate the technical features of the invention, and not to limit the invention.

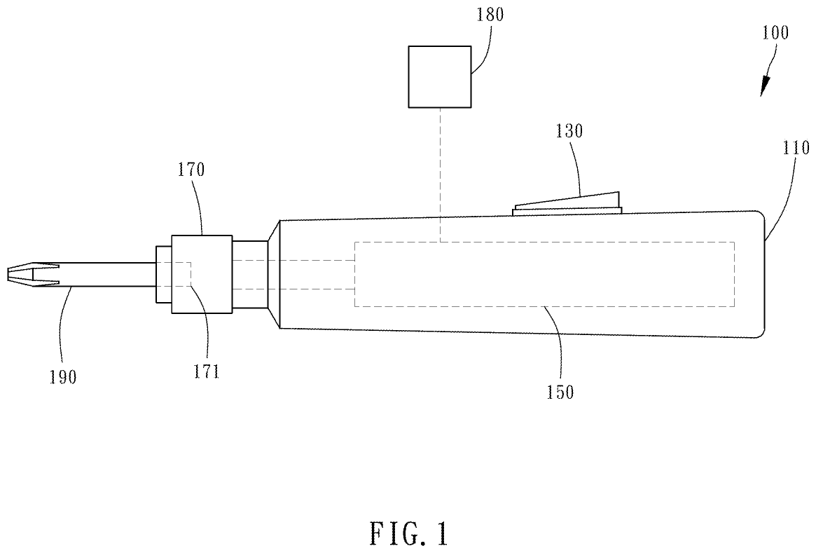

Referring to FIG. 1, a power tool 100 comprises a housing 110, a trigger 130, an electric drive 150, an adapter 170 and a remote device 180. The housing 110 can be assembled from a plurality of shells and can be of any shape. The trigger 130 is located on the housing 110. The electric drive 150 is mounted inside the housing 110 and electrically connected to the trigger 130. The adapter 170 is connected to the electric drive 150 and has a connector 171 for selectively receiving a screwing device 190, such as a screwdriver. The trigger 130 is used to trigger the electric drive 150 to drive the adapter 170 and the screw device 190, thereby locking or loosening the screw component (such as nut, screw, etc.) The remote device 180 can be installed on the housing 110 or separated from the housing 110. The remote device 180 is coupled to the electric drive 150 by a signal line or wireless communication technology.

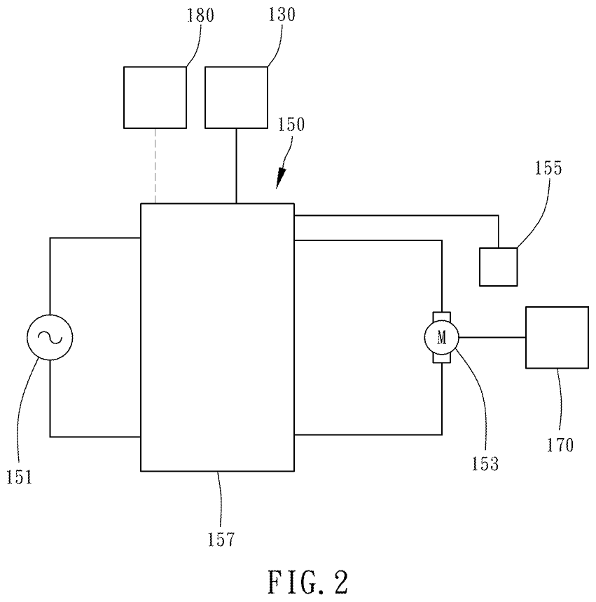

Referring to FIG. 2, the electric drive 150 comprises a power supply device 151, an electric motor 153, a torque sensor 155 and a driving device 157. The power supply device 151 is connected and powered to the electric motor 153 and the driving device 157. The power supply device 151 can be a battery pack or an external power source via a wire. The shaft of the electric motor 153 is connected to the adapter 170 to drive the adapter 170. The electric motor 153 can be a brushed DC motor, brushless DC motor or other AC motor. The torque sensor 155 senses the change in output torque of the electric motor 153. The driving device 157 is connected to the electric motor 153 and coupled to the torque sensor 155 to control the operation of the electric motor 153. How the driving device 157 controls the operation of the electric motor 153 will be described in detail later.

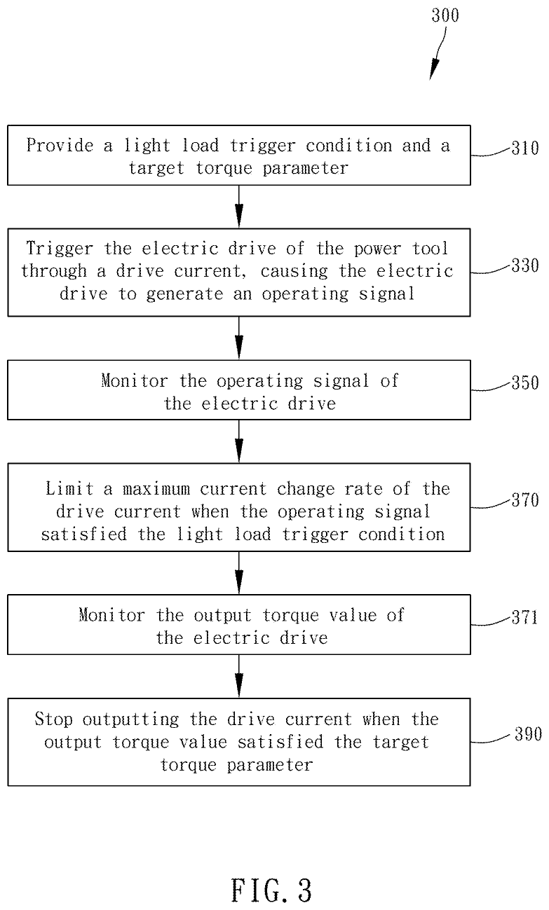

Referring to FIG. 3, the power tool operation method 300 includes six steps. Step 310 is to provide a light load trigger condition and a target torque parameter. Step 330 is to trigger the electric drive of the power tool through a drive current, causing the electric drive to generate an operating signal. Step 350 is to monitor the operating signal of the electric drive. Step 370 is to limit a maximum current change rate of the drive current when the operating signal satisfied the light load trigger condition, so that the electric drive operates at a reduced speed. Step 371 is to monitor the output torque value of the electric drive. Step 390 is to stop outputting the drive current when the output torque value satisfied the target torque parameter. In other embodiments, the number of steps may be more or less, and the order may be adjusted. The maximum current change rate of the drive current refers to the current value generated after the operating signal satisfies the light load trigger condition.

To trigger the electric drive of the power tool in step 330 is done through the trigger 130 shown in FIG. 1, however, this is not a limitation. In steps 330-350, the operation of the power tool is a light load operation. In steps 370-390, the operation of the power tool is a heavy load operation. In the process of locking, taking screws and nuts as an example, the light load operation is that the bottom surface of the screw head or nut has not touched the surface of the screwed component, but after the two touch, the output resistance of the electric motor will increase (switch to heavy load operation), so that the drive current increases rapidly and locks in a short time. Therefore, the drive current has different slopes during light load operation and heavy load operation. The drive current is usually gradually increasing during light load operation, but the drive current rapid increase phase can be defined as heavy load operation. The change of the drive current will affect the state of the operating signal. Therefore, the electric drive can monitor the increase speed (slope) of the operating signal through the light load trigger condition to obtain the transition time point of the light load operation and the heavy load operation. The operation method 300 of the present invention normal accelerates the rotation of the screwed component during the light load operation, but slowly reduces the rotation speed and monitors the output torque value during the heavy load operation. Thus, the operation method 300 can effectively shorten the screwing time, and the torque value can be accurately controlled at a low speed to control the output torque, and the reaction force of the electric drive can be reduced.

The target torque parameter of step 310 can be provided by the remote device 180. In the wireless communication part, those skilled in the art can understand that the remote device 180 can communicate with the electric drive 150 to transmit, receive and display information such as torque parameters and torque values. Therefore, the driving device 157 including a communication unit (such as an antenna) not shown in the drawing receives the torque parameter transmitted by the remote device and transmits the torque value and the like to the remote device. In other embodiments, the torque parameter in step 310 may be a fixed value built into the driving device 157, or an adjustable torque parameter that can be written or changed.

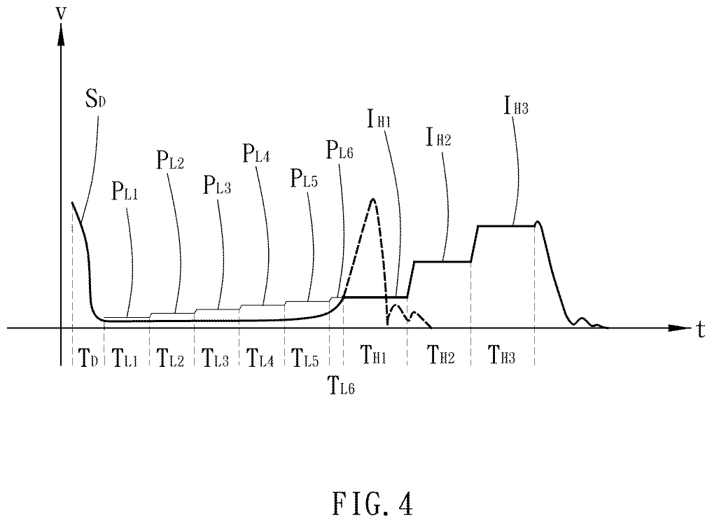

As shown in FIG. 4, FIG. 4 is a waveform diagram of the drive current corresponding to the drive current measured by an oscilloscope. According to the prior art, the locking operation is completed at a high speed operation, and when the locking is approached, the operating signal corresponding to the drive current is rapidly increased until the locking signal is turned off (as shown by the thick broken line in the figure), so that when locked the electric motor is high speed off. However, the present invention monitors the drive signal at light loads and limits the maximum current increase of the drive current during heavy loads to allow the electric motor to shut down at low speeds.

The light load trigger condition is that the driving device 157 establishes a plurality of light load triggering periods TL1-TL6 and a plurality of light load triggering parameters PL1-PL6 respectively corresponding to the light load triggering periods TL1-TL6 during the acceleration operation period. The plurality of light load triggering periods TL1-TL6 are continuous, and the plurality of light load triggering parameters PL1-PL6 are different and gradually increase. In other embodiments, the light load trigger condition and the light load triggering parameter may be more or less, and therefore, the number is not limited to six.

In other embodiments, the light load trigger condition is established in the driving device 157, which may be a fixed (preset) mode or a tracking mode. The fixed mode, for example, establishes a fixed light load triggering parameter regardless of the time change, and the tracking mode is to adjust the light load triggering parameter with time. For example, in FIG. 4, each light load triggering period TL1-TL6 is 50 milliseconds to establish a corresponding light load triggering parameter, and the light load triggering parameter is gradually increased, but not limited to 50 milliseconds, and the light load triggering parameter value may be established based on experience or data analysis.

Step 330 is triggered by the trigger 130, so that the driving device 157 supplies the drive current to the electric motor 153, and the electric motor 153 operates. At this time, the electric motor 153 is a light-loaded fast operation, that is, the speed is getting faster and faster. At light load, the resistance of the electric motor 153 is gently increased. Therefore, the rising slope of the drive current and the corresponding operating signal are gently increased.

Step 350 is to monitor the operating signal of the electric motor 153 through the built-in hardware circuit or external device of the driving device 157. In this embodiment, the operating signal is related to the driving (feedback) current of the electric motor 153. In other embodiments, the operating signal may be a corresponding motor power or other electrical signal.

In this embodiment, the monitoring step of step 350 is to delay a startup period T_{D} to detect the drive current after the electric drive is triggered at the startup flash. The startup period T_{D} is to avoid the signal of the large starting current at the moment of start. During the start of detecting the drive current, the driving device 157 calculates the average value of the drive current during each light load triggering period and adds a compensation value to the average value to establish a light load triggering parameter for the next period. Compensation can also be subtracted from differences or other logical processing. In other embodiments, the compensation step may be omitted. The difference may be fixed or defined by reference to the change in drive current during the previous period.

In step 370, the operating signal satisfies the light load trigger condition is that the operating signal reaches the light load triggering parameter of one light load triggering period. As shown in FIG. 4, “reach” means that the operating signal S_{D} exceeds the light load triggering parameter P_{L6}. In other embodiments, “reach” means that the operating signal S_{D} is equal to the light load triggering parameter P_{L6}.

limiting the maximum current change rate of the drive current is to slow down the increase of the drive current by controlling the maximum current to operate the electric motor 153 at a low speed. As shown in FIG. 4, limiting the rate of change of the drive current includes outputting the first heavy load drive current I_{H1} in the first reloading triggering period T_{H1}, and then outputting the second heavy load drive current I_{H2} in the second (next) reloading triggering period T_{H2}, and finally the third heavy load drive current I_{H3} is output during the third heavy load triggering period T_{H3}.

The first heavy load drive current I_{H1}, the second heavy load drive current I_{H2} and the third heavy load triggering period T_{H3} are gradually increased (large). Those skilled in the art will appreciate that the number of heavy load triggering periods and the number of heavy load drive currents at each stage may be greater, that is, there may be more or less grading of the heavy load triggering period and the heavy load drive current.

Monitoring the output torque value in Step 371 is to sense the output torque value of the electric motor 153 using a mechanical torque sensor (such as a clutch trip structure) or an electronic torque sensor (such as a strain gauge). The output torque value (signal) can be transmitted to the driving device 157 via a signal line or wirelessly. The mechanical torque sensor or the electronic torque sensor are well known in the industry and will not be described here.

When the operating signal does not meet the light load trigger condition, step 330 and step 350 are continuously performed.

In step 390, when the output torque value of the electric motor 153 meets the target torque parameter, the output drive current is stopped to stop the electric motor 153 from rotating. Referring to FIG. 4, in this embodiment, during the third heavy load triggering period, the output torque value satisfies the target torque value, so the output of the third heavy load drive current I_{H3} is stopped, so that the electric motor 153 stops rotating. It should be noted that in step 370, the speed of the electric motor 153 is gradually reduced to a very low speed by limiting the maximum current increase speed of the drive current, so that there is almost no reaction force when the electric motor 153 is stopped. Therefore, the power tool operation method 300 of the present invention can more accurately control the output torque value and can more effectively lock the screw component.

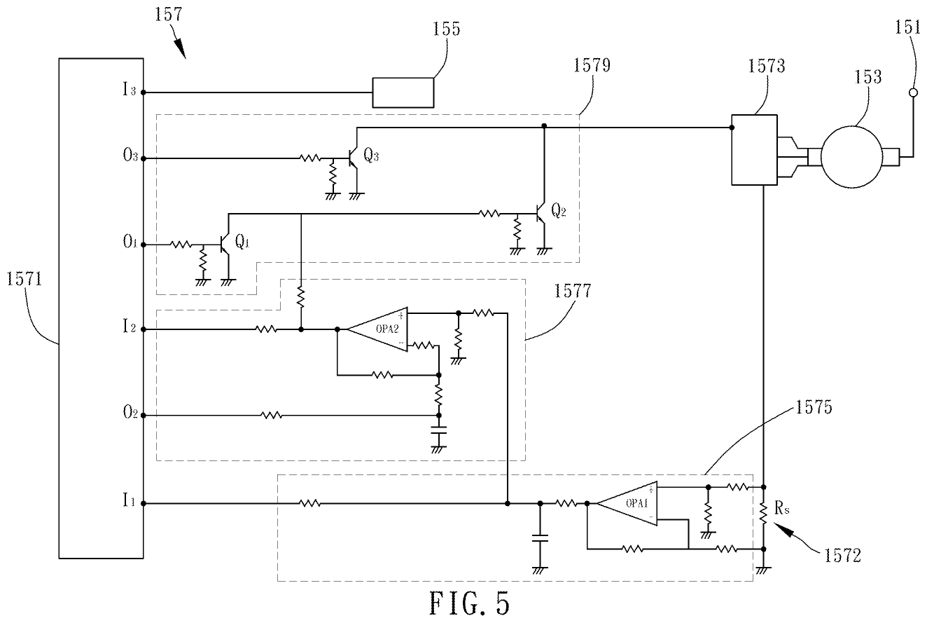

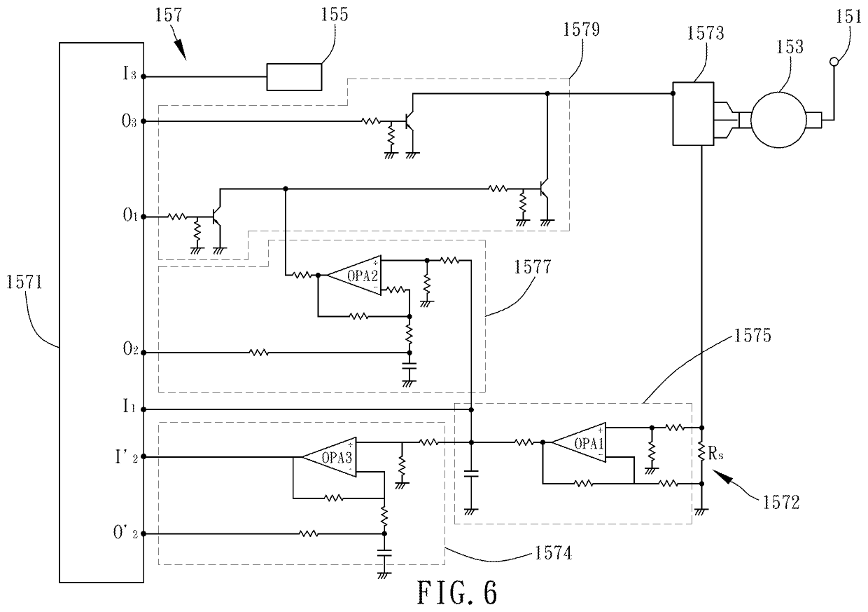

The power tool operation method 300 of the present invention can be implemented by software (program) or hardware (circuit). The software (program) implementation is to record the logic program corresponding to the operation method 300 on a microprocessor of the driving device for execution. The hardware (circuit). Implementation is illustrated by FIG. 5 and FIG. 6.

As illustrated in FIG. 5, the driving device 157 comprises a microprocessor 1571, a current sensor 1572, a motor switch 1573, an amplification circuit 1575, a monitoring circuit 1577 and a current limiting circuit 1579. The microprocessor 1571 is connected to the torque sensor 155, the motor switch 1573, the amplification circuit 1575, the monitoring circuit 1577 and the current limiting circuit 1579. The motor switch 1573 is connected to the electric motor 153, the current sensor 1572 and the current limiting circuit 1579. The amplification circuit 1575 is connected to the current sensor 1572. monitoring circuit 1577 is connected to the amplification circuit 1575 and the current limiting circuit 1579. The torque sensor 155 is connected to the input end I₃ of the microprocessor 1571 to output the torque signal to the microprocessor 1571, i.e., to execute step 371. The input terminals I₁-I₃ of the microprocessor 1571 are adapted for receiving signals. The output terminals O₁-O₃ of the microprocessor 1571 are used to output signals to control the corresponding circuits.

The motor switch 1573 can be composed of one or more power semiconductor components with a motor driver to control the electric motor 153. The current sensor 1572 is used to sense the operating signal of the electric motor 153. In this embodiment, the current sensor 1572 is a resistor R_{S} used to convert motor current into operating (voltage) signal. The amplification circuit 1575 can be composed of an operational amplifier or differential pressure amplifier. The amplification circuit 1575 comprises a first operational amplifier OPA1. The first operational amplifier OPA1 has the forward input terminal and inverting input terminal thereof coupled to the current sensor 1572 in parallel, and the output terminal thereof coupled to the input terminal I₁ of the microprocessor 1571 and the monitoring circuit 1577. The first operational amplifier OPA1 outputs the operating signal detected by the current sensor 1572 to the monitoring circuit 1577 and the microprocessor 1571, enabling the microprocessor 1571 to obtain the operating signal. The current sensor 1572 and the amplification circuit 1575 are used to execute step 350. The coupling can be a direct connection or through other electronic components (such as resistors, capacitors, or their combinations).

The microprocessor 1571 determines whether the operating signal meets the light load trigger condition through a built-in software, program or logic. In other words, the light load trigger condition is established in the microprocessor 1571, that is, the step of determining whether the step S370 is satisfied is performed by the microprocessor 1571.

The monitoring circuit 1577 is used to control the drive current by means of the operating signal. The monitoring circuit 1577 comprises a second operational amplifier OPA2. The second operational amplifier OPA2 has the forward input terminal coupled to the amplification circuit 1575, the inverting input terminal thereof coupled to the output terminal O₂ of the microprocessor 1571 and the output terminal thereof coupled to the current limiting circuit 1579 and the input terminal I₂ of the microprocessor 1571. The coupling can be a direct connection or through other electronic components (such as resistors, capacitors, or their combinations).

The output terminal O₂ of the microprocessor 1571 outputs the light load triggering signal and the heavy load triggering signal. The inverting input terminal of the second operational amplifier OPA2 is used to receive the light load triggering signal and the heavy load triggering signal. The forward input terminal of the second operational amplifier OPA2 is used to receive the operating signal. In step 370, the microprocessor 1571 first outputs the light load triggering signal, so that the second operational amplifier OPA2 compares the light load triggering signal and the operating signal. When the microprocessor 1571 determines that the operating signal meets the light load trigger condition, the microprocessor 1571 turns to output the heavy load triggering signal. The second operational amplifier OPA2 compares the heavy load triggering signal with the operating signal to cause the microprocessor 1571 to control the rate of change of the maximum current of the drive current to reduce the rotational speed of the electric drive. Controlling the rate of change of the maximum current of the drive current is that the microprocessor 1571 drives the current limiting circuit 1579 to operate and gradually increases the voltage value of the output terminal O₂, and performs steps S370 and S390 to control the increase of the drive current until the output torque value satisfies the target torque parameter, as the heavy load triggering period T_{H1}-T_{H3} and the heavy load drive current I_{H1}-I_{H3} shown in FIG. 4.

In this embodiment, the light load triggering signal and the heavy load triggering signal are created by the microprocessor that directly outputs the DC voltage level, or the PWM signal passing through the resistor and capacitor of the inverting input terminal of the second operational amplifier OPA2.

The current limiting circuit 1579 comprises a first transistor Q1, a second transistor Q2 and a third transistor Q3. The base of the first transistor Q1 is coupled to the microprocessor 1571. The emitter of the first transistor Q1 is coupled to the ground terminal. The collector of the first transistor Q1 is coupled to the base of the second transistor Q2. The emitter of the second transistor Q2 is coupled to the ground terminal. The collector of the second transistor Q2 is coupled to the collector of the third transistor Q3 and the motor switch 1573. The emitter of the third transistor Q3 is coupled to the ground terminal. The base of the third transistor Q3 is coupled to the microprocessor 1571. The coupling can be a direct connection or through other electronic components (such as resistors, capacitors, or their combinations).

When entering heavy load operation, the microprocessor 1571 controls the first transistor Q1 to turn off The second operational amplifier OPA2 outputs transition signal to control the second transistor Q2 to perform constant current control of the drive current, that is, step 370 to limit the maximum current change rate of the drive current, It limits the drive current supply to the motor switch 1573 by controlling the second transistor Q2 to turn on and off to achieve constant current control. Until the output torque value of the electric motor 153 reaches the target torque value, the microprocessor 1571 triggers the third transistor Q3 to turn on and stops supplying the drive current to the motor switch 1573 (i.e., performs step 390).

In other embodiments, determining whether the operating signal satisfies the light load trigger condition may also pass through a hardware circuit.

As shown in FIG. 6, FIG. 6 further includes a current detecting circuit 1574 compared to the driving device 157 of FIG. 5, and the current detecting circuit 1574 comprises a third operational amplifier OPA3. The forward terminal of the third operational amplifier OPA3 is coupled to the output terminal of the first operational amplifier OPA1 to receive the operating signal. The inverting input terminal of the third operational amplifier OPA3 is coupled to the output terminal O′₂ of the microprocessor to receive the light load triggering signal from the microprocessor. Therefore, compared with the embodiment of FIG. 5, the output terminals O′₂ and O₂ of the microprocessor 1571 of the present embodiment respectively output a light load triggering signal and a heavy load triggering signal. The output terminal of the third operational amplifier OPA3 is coupled to the input terminal I′₂ of the microprocessor to output a comparison result of the light load triggering signal and the operating signal to the microprocessor. Then, when the operating signal satisfies the light load trigger condition, the output terminal O₂ of the microprocessor 1571 outputs a reload triggering signal, which is the same as the embodiment of FIG. 5, and therefore will not be described again. The coupling may be directly connected or transmitted. Other electronic components (such as resistors, capacitors or combinations) are connected. The coupling can be a direct connection or through other electronic components (such as resistors, capacitors, or their combinations).

The third operational amplifier OPA3 compares whether the operating signal satisfies the light load trigger condition, that is, it can be used as a circuit for judging whether it is out of light load.

In other embodiments, when the constant power control mode is determined during the heavy load period, the constant power control mode is that the microprocessor 1571 outputs a PWM signal to control the third transistor Q3. PWM signal has a fixed period. Therefore, the monitoring circuit in FIGS. 5 and 6 can be omitted and the maximum current value of the drive current is controlled by the microprocessor.

According to the above description, the judgment during light load or heavy load can be performed by the microprocessor. Therefore, the operation method of the present invention is not limited to the microprocessor with the hardware circuit.

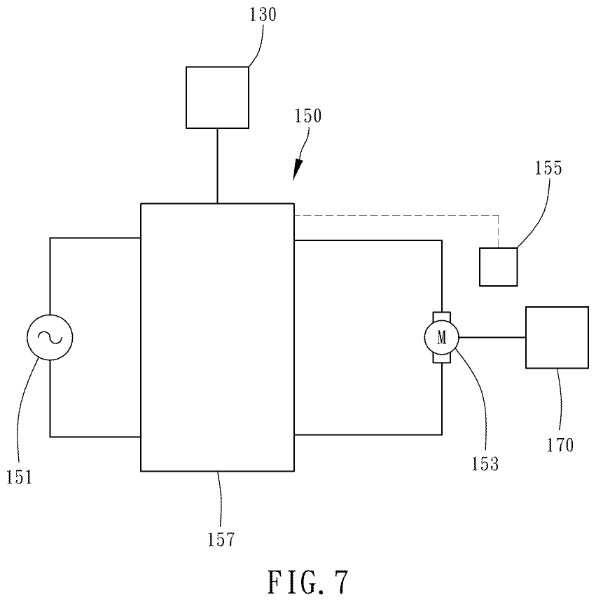

As shown in FIG. 7, the electronic torque sensor 155 having a wireless communication function generally includes a battery (not shown). The battery-powered electronic sensor 155 can communicate wirelessly with the driving device 157 (as shown by the dotted line in the drawing, indicating that the two are communicating via wireless). Therefore, in order to reduce the power consumption of the battery, the torque sensor is in a sleep state of micro power consumption at light load. After leaving the light load (step S370), the driving device 157 wakes up the electronic torque sensor 155 by a signal to perform monitoring of the output torque value (i.e., step S371) until the electronic torque sensor 155 is returned to the sleep state after implementing step S390. In this way, the battery life can be extended, thereby extending the use time of the electronic torque sensor 155. The electronic torque sensor 155 can be a single individual that can be combined or detached from the power tool in an alternative manner to facilitate production and after-sales services.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A power tool operation method, comprising the steps of:
providing a light load trigger condition and a target torque parameter;
triggering an electric drive of a power tool through a drive current to cause said electric drive to generate an operating signal;
monitoring said operating signal of said electric drive;
limiting a maximum current change rate of said drive current when said operating signal satisfied said light load trigger condition, so that said electric drive operates at a reduced speed;
monitoring an output torque value of said electric drive; and
stopping the output of said drive current when said output torque value satisfied said target torque parameter.

2. The power tool operation method as claimed in claim 1, wherein said light load trigger condition comprises establishing a plurality of light load triggering periods and a plurality of light load triggering parameters respectively corresponding to said plurality of light load triggering periods, said plurality of light load triggering periods being continuous, said plurality of light load triggering parameters being different; and said operating signal satisfied said light load trigger condition is that said operating signal is equal to or exceeds one of said plurality of light load triggering parameters.

3. The power tool operation method as claimed in claim 1, wherein said plurality of light load triggering parameters are related to an average of said drive current during said plurality of light load triggering periods.

4. The power tool operation method as claimed in claim 1, wherein the step of limiting the maximum current change rate of said drive current comprises outputting a first heavy load drive current during a first heavy load triggering period, and then outputting a second heavy load drive current during a second heavy load triggering period, said second heavy load drive current being greater than said first heavy load drive current.

5. The power tool operation method as claimed in claim 1, wherein the step of monitoring said operating signal of said electric drive comprises delaying a start period to detect said drive current after said electric drive is triggered.

6. The power tool operation method as claimed in claim 1, wherein the step of monitoring said output torque value of said electric drive comprises triggering a torque sensor of said electric drive to detect said output torque value when said operating signal satisfied said light load trigger condition.

7. The power tool operation method as claimed in claim 1, wherein the step of providing said target torque parameter by a remote device.
